(19) United States
(12) Patent Application Publication
(10) Pub. No.: US 2003/0138653 A1
(43) Pub. Date: Jul. 24, 2003

(54) Transparent or partially transparent packaging materials that are coloured by means of colours

(76) Inventors: Klaus Rieblinger, Freising (DE); Ulrich Moosheimer, Hohenkammer (DE); Gottfried Ziegleder, Munchen (DE)

Correspondence Address: HUNTON & WILLIAMS, INTELLECTUAL PROPERTY DEPARTMENT, 1900 K STREET, N.W., SUITE 1200, WASHINGTON, DC, 20006-1109, US

(21) Appl. No.: 10/203,511

(22) PCT Filed: Feb. 12, 2001
(86) PCT No.: PCT/EP01/01524

(51) Int. Cl. B32B 27/00

(52) U.S. Cl. 428/515; 428/523; 428/500

(57) ABSTRACT

This invention concerns packages which are at least partially light-transmissive. The packages are intended particularly for foods, cosmetics and pharmaceuticals, but they are also intended for other natural products or products containing natural substances which contain natural coloring materials or which are colored with coloring materials which are natural or are identical to the natural ones. The invention further concerns the use of at least partially light-transmissive packages which are colored with approved dyes for foods, cosmetics and pharmaceuticals.

### BACKGROUND OF THE INVENTION

1. Field of the Invention

This invention concerns packages which are at least partially light-transmissive. The packages are intended particularly for foods, cosmetics and pharmaceuticals, but they are also intended for other natural products or products containing natural substances which contain natural coloring materials or which are colored with coloring materials which are natural or are identical to the natural ones. The invention further concerns the use of at least partially light-transmissive packages which are colored with approved dyes for foods, cosmetics and pharmaceuticals.

2. Description of Related Art

Coloring materials in foods are often present naturally, so that they also occur as natural components of prepared foods. The principal natural coloring materials found in foods are from the groups of the carotenoids, chlorophylls, betalains, anthocyanidins and flavanones.

Animal and plant foods in particular spoil from the effects of oxygen and light. The colors of the foods change. They fade so that the food no longer appears fresh, or they spoil. Also, some food coloring materials are excited by visible light. Then they react with oxygen that may be present. For instance, chlorophylls and their degradation products, the red-orange riboflavin (Vitamin B2), and the red myoglobin exhibit specific reactivity with oxygen on illumination with visible light. These coloring materials act as photosensitizers and can use the light energy to activate oxygen from its normal single state to an excited triplet state. Oxygen excited in that manner can, for instance, immediately oxidize the double bonds of unsaturated fatty acids. That produces changes in quality which the consumer perceives as rancidity of the fatty portion. This proceeds immediately, depending on light, and requires no induction phase, as does classical fatty acid oxidation. In the past, complete protection from light has been necessary to prevent such photosensitized reactions.

Dyes in packaging films protect the packaged goods from light, but also act as visual eye-catchers for customers. The synthetic dyes and pigments used today are characterized by, among other things, their light stability. Reviews on this subject can be found in W. Baumann and A. Muth, Dyes and Paints 1(2); Data and facts for environmental protection, Springer-Verlag 1997, or in dictionaries such as Ullmann or Römpp.

The degradative reactions can be prevented in products with opaque packaging by keeping the reactants, oxygen and light, separated (see, for example, K. Rieblinger and G. Ziegleder: Packaged Foods as Affected by Light: Susceptibility of complex chlorophyll-containing products, Zeitschrift für die Lebensmittelwirtschaft (ZFL) 01/98, or M. Krug and G. Ziegleder: Susceptibility of white chocolate to light, Part I (Fat oxidation involving sensitizers) and Part II (Improved keeping quality with protective gas packaging), Zeitschrift für die Süsswarenwirtschaft (ZSW) 1-2/98, 24-27 and ZSW 3/98, 102-104). According to them protection from light radiation requires selection of packaging materials with the very minimum light transmission and storing the packaged goods in the dark as much as possible. It is also known that UV absorbers, antioxidants, and biocides can be incorporated in the packaging material (see, for example, K. Rieblinger et al., Light protection for foods—Partial protection by UV filters in the packaging materials, 6/98, 36-38, or Campden & Charley Wood, Food Research Association, New Technologies Bulletin No. 17, 09/1998, 1-26).

Extending the storability by means of the effects attained that way would be desirable. But consumers would like to examine the goods they are buying visually before they buy them or use them.

### SUMMARY AND OBJECTS OF INVENTION

Thus the objective of the present invention is provision of transparent or at least partially transparent packaging materials which do not exhibit the disadvantages mentioned above.

This objective is achieved by preparing transparent or partially transparent packaging materials with dyes having the same absorption spectrum as the coloring materials in the goods being packaged, or a similar absorption spectrum. Preferably they are the same coloring materials. Organic and perhaps metal-containing dyes are also preferred as dyes.

The expression “dye” is intended to be understood broadly here, and to include all coloring agents except for the natural and synthetic inorganic pigments. However, coloring agents which are soluble in solvents or polymers are preferred in the invention. That is the preferred group does not include organic pigments. Particularly preferred in this invention are the organic dyes, which may contain metals, and those listed at the beginning are very specially preferred.

In one particularly preferred embodiment of the invention, the packaging materials produced contain dyes which are natural or which are identical to the natural ones. The goods to be packaged can include, in particular, foods, pharmaceuticals or cosmetics, as well as other goods subject to spoilage, which are or contain natural products. Particularly preferably, the same natural coloring materials as the ones in the goods to be packaged (or ones produced synthetically) are incorporated into the packaging materials.

Further according to the invention, transparent or partially transparent packaging materials are produced with those dyes which are also used to color the goods being packaged. These too can be synthetic dyes.

The packaging materials according to the invention can also be parts of a package, such as windows in otherwise opaque packages or inner/outer bags.

### DETAILED DESCRIPTION OF PREFERRED EMBODIMENTS

Coloring of foods is allowed within a specified extent. Table I gives a survey of the compounds currently approved which are of partially natural and partially synthetic origin. It is taken from Belitz and Grosch, Lehrbuch der Lebensmittelchemie [Textbook of Food Chemistry], Springer-Verlag 1992. Its current status appears in LMBG [Lebensmittel und Bedarfsgegenstandegesetz; Law on foods and objects of daily use]. That also contains specific examples of foods in which the coloring agents are used.

Cosmetics, pharmaceuticals containing natural components, and the like often contain natural coloring materials. Optionally, dyes may be added. As they are consumed, or come into contact with the human body, they must meet certain requirements. The accompanying Table III lists the coloring agents approved in Appendix 3 of §3 of the publication of the new edition of the Cosmetics Regulation of Oct. 7, 1997 in the edition of Dec. 18, 1998. The accompanying Table IV corresponds to the appendix of the Medical Dye Regulation (AMFarbV) of Aug. 25, 1982 in an implementing statue for the EWR of Apr. 27, 1993.

If dyes are selected and incorporated into at least partially transparent packaging materials for appropriate goods so that the dye or dyes are identical with the coloring materials of the goods being packaged, or at least have the same absorption spectrum, those dyes will filter out from the light spectrum specifically those wavelengths which are critical for the packaged goods (such as a food), while “harmless” wavelengths can pass. This improves the storability of the goods and delays potential spoilage because those wavelengths which cause excitation of the photosensitive and so cause spoilage can no longer get to the surface of the goods being protected. A dye or pigment with a different absorption spectrum, in contrast, filters out only part of the critical spectrum because its absorption spectrum does not coincide exactly with that of the dye(s) or coloring materials.

Of course, it is desirable for this application that the dye or dyes of the packaging material retain their function over the entire storage life of the packaged goods. Thus the dyes themselves must be sufficiently stable. While numerous dyes exhibit this stability in or on the packaging material directly (i.e., they themselves are not attacked as long as they are spatially separated from potentially critical substances in the packaged material, such as fatty acids or fats in foods), it may for other such dyes be desirable to assure their storability in or on the packaging material by suitable measures. These include, primarily, exclusion of oxygen or reduction of access of oxygen to the dye. Thus in many embodiments of the invention it is particularly desirable to incorporate the dye (optionally with exclusion of oxygen) directly into the packaging materials. Thus it may be a component of the plastic material or the like for the films which are extruded or otherwise produced. It may be an intermediate layer in a multilayer packaging material such as a laminated film. It is also possible to protect the dye from oxygen by a protective coating or similar covering if it is applied as, or in, a coating material on the packaging material (such as glass or a less-flexible plastic). This invention, then, provides transparent packaging materials which, while complying with the generally applicable requirements, contain natural coloring materials, or coloring materials identical to the natural ones, such as substances like riboflavin, hemoglobin, or chlorophyll which occur in foods, and which are stable sufficiently long, generally for several weeks or even months. That can be accomplished, for instance, if these dyes, or dyes which behave similarly, are incorporated into the material from which transparent films are drawn, extruded, or otherwise produced, in, for example, polyethylene, polypropylene, or poly(ethylene terephthalate).

The packaging materials according to the invention can offer other advantages in a different embodiment of the invention. As noted, many natural coloring materials, or coloring materials identical with the natural ones, are unstable because of the photosensitization described above, usually in the presence of oxygen. They are themselves subject to a chemical reaction, and fade or lose their color. If such dyes are used in the packaging material according to the invention, and if they are applied to or incorporated in the packaging material so that they fade detectably to the naked eye over several weeks or months exposure to the action of light, that property can be utilized as an indicator for the packaged material. The dealer or consumer can see, from the package, whether the package has been exposed to light for too long. If the natural coloring material, or one identical with the natural coloring material, is applied to the packaging material so that it is in contact only with the atmosphere inside the package, then, if the packaged goods is packaged in inert gas, the indicator function can be used as an indicator of the storability of the packaged goods after opening, or as an indicator of a possible leak in the package, as the color changes begin on opening or occurrence of the leak with the beginning of entrance of oxygen. Thus this is an indicator reaction with which one can get information abut the duration of exposure to light and/or oxygen. That can also be important for those packaged materials which should be stored in a refrigerated or a dry (dark) room. The reaction also allows detection of qualitatively bad or erroneous packages; or detection of manipulations which might, for example, be feared in attempts at food-related extortion. In this embodiment of the invention, the packaging material used can be transparent, but it need not be so.

Of course, the dye in or on the packaging should be stable enough, in this embodiment too, so that it does not fade completely in a few days. Therefore it is not desirable to expose it to an oxidizing environment in or on the packaging if it naturally bleaches very rapidly in the presence of oxygen. In this embodiment, then, it is preferable to incorporate the dye into a material which at least delays the entry of oxygen, so that only the regions near the surface bleach, perhaps rapidly, while the dye in the core of the packaging material lasts longer, or to coat the layer containing the dye with a protective coating.

In one very specific embodiment of the invention, which is particularly suited for packaging foods, cosmetics, or pharmaceuticals that can be stored for several weeks or months, a dye is incorporated into a transparent packaging material so that the color weakens by about 15% to 70% in about 2 to 36, preferably up to 12 weeks, such that on one hand it carries out the protective function described and, on the other hand, also can indicate the aging of the stored food or the access of light or oxygen to it. That can be done, for example, by incorporating dyes moderately stable to oxidation into the coating materials applied to the transparent packaging material (e.g., a color, a glass), or by incorporating dyes less stable to oxidation in a coating paint which is coated on the packaging material with a protective varnish.

TABLE I
Dyes approved for coloring foods

| E number | Dye | Color |
|---|---|---|
| E102 | Tartrazine | Lemon yellow (W) |
| E101 | Riboflavin | Yellow (W) |
| E100 | Curcumin | Reddish yellow (E) |
| | Zeaxanthin | Yellow (oil) |
| E110 | Yellow Orange S | Orange (W) |
| E160a | β-Carotene | Orange (oil) |
| E160b | Bixin | Orange (oil) |
| E160d | Lycopene | Orange (oil) |
| E161g | Canthaxanthin | Orange (oil) |
| | Astaxanthin | Orange (oil) |
| E160e | β-Apo-8′-carotenal | Orange (oil) |
| E122 | Azorubin | Bluish red (W) |
| E123 | Amaranth | Bluish red (W) |
| E124 | Ponceau 4 R | Scarlet red (W) |
| E120 | Carmine | Bright red |
| E163a-f | Anthocyanidines | Red-violet (W) |
| E127 | Erythrosin | Cherry-red (W) |
| | Red 2 G | Bluish red (W) |
| E132 | Indigotin | Purplish blue (W) |
| E131 | Patent Blue V | Greenish blue (W) |
| | Brilliant Blue FCF | Greenish blue (W) |
| E140 | Chlorophyll | Green |
| E141 | Copper-chlorophyllin | Green (W) |
| | complex | |
| E142 | Brilliant Acid Green | Green (W) |
| D151 | Brilliant Black BN | Bluish violet |

As noted, organic dyes, sometimes metal-containing dyes, are particularly suited for the present invention. Dyes which occur naturally in foods, such as chlorophyll, riboflavin, carotene, carotenoids, hemin or myoglobin and derivatives of them are particularly preferred. For example, chlorophyll in the packaging material is suitable for all foods that contain chlorophyll. Those include especially vegetable oils (particularly, for example, olive oil, walnut oil or pumpkin seed oil) and cocoa butter (a component of white chocolate) with high fat content. They also include foods such as noodles colored with spinach or other green vegetables, baby food with spinach or broccoli, and foods containing them, such as frozen pizzas, dried soups, and dried vegetables. Riboflavin in particular can be added to all packaging materials intended for milk, foods containing milk and milk products, products containing yeast, and products colored and/or fortified with riboflavin. Packaging materials for products containing carotenoids, which contain carotene and/or sensitizers, should contain carotene and/or carotenoids. Carotenes and carotenoids compete with sensitizers for interaction with light, and so prevent or reduce photosensitized fat oxidation. In the process, carotenes and carotenoids lose their color and effectiveness over time. Use of hemin and/or myoglobin and/or their derivatives is advantageous for meat and meat products. Furthermore, for instance, the substances listed in Table I, above, can be incorporated into packaging materials in a suitable manner. Obviously, mixtures of dyes can also be used.

As noted previously, another potential application of the present invention is packaging of cosmetics and medications which contain the coloring materials approved for that purpose (see Tables II and III). According to the invention, the at least partially transparent packages for such goods contain the dye (or several dyes) with which the good being packaged was colored and/or those which the goods contain naturally. The dye or dyes can be of natural origin, identical with the natural ones, or partially or completely synthetic. Examples of such packages are films for coated tablets, or glass or plastic bottles. See also in this respect, L. Santamaria and G. Prino: List of the Photodynamic Substances, Res. Progr. Org. Biol. Med. Chem 3(1972) 11-35. For example, an extract of St. John's wort has photosensitizing action.

As mentioned, the packaging materials according to the invention can contain the dye or dyes either incorporated directly into the transparent material, or they may have a coating or layer which contains the dye over the entire surface or (if only the indicator function is needed) over part of the surface (e.g., as a label or logo). Possible packaging materials, coating materials, and layer materials include paper/cardboard/plastic, adhesives, printed colors (Flexidruck, Tiefdruck), dyes or varnishes. Well-suited materials among them are those partially or completely grown as crops.

The material used as the plastic is essentially unlimited, as long as the dye is compatible with it. Thermoplastics, elastomers, crosslinkable resins and the like can be used. If the packaging consists of a transparent plastic, or if it is supposed to contain such a material, as in the form of a window, the dye can be incorporated into the un-crosslinked or unhardened precursor of the plastic before the packaging is shaped, during extrusion, for instance, to the extent that it has a role in shaping. Dyed films (un-drawn “cast films”, or foils shaped as flat, tubular, calander or bubble foils), sheets, tubes, bubble-shaped hollow bodies (such as bottles or wide-neck containers), injection-molded objects (bottles or containers) or injection-blown objects (bottles, cups, boxes, containers) are produced in this manner, for example. Extrusion can be done with just one material, or by coextrusion. When preforms are involved, they can be made of packages which have fixed shape, such as cups, bottles, shells or tubs; semirigid packaging materials, such as plastic dishes, or soft packaging materials such as trays, blisters or bags, by thermoforming, for example. Of course, there are other possibilities for incorporating the dye into the polymer mass to be shaped, or into its precursors. Such methods are well-known to those skilled in the art.

Other materials suitable according to the invention are those which adhere as a coating to a substrate or can be processed into self-supporting layers (films) other than by extrusion. Resins which may be considered include acrylic resins, polyurethane resins, epoxy resins, or coatings produced with sol-gel processes, for instance, with the aid of hydrolysis/condensation of organically modified silanes and/or alkoxy compounds of other metals (“silane resins”). The dye can be added at a suitable step of coating production, for instance, in the un-crosslinked resin composition before applying the coating. The compositions mentioned can then either be applied to a transparent or partially transparent substrate (such as plastic or glass) or processed into films, in which one can, for instance, obtain composite films by known processes. For transparent or semitransparent films, the dye changes the color of the composite film. Coatings can also be applied by known processes, as by spin-coating, spraying, varnishing, and the like.

If a composite material is intended to be a packaging material, the dye can if desired also be present solely or additionally in an adhesive with which the two components are combined for example, a film with a plastic or glass substrate, or multiple films combined into a composite film. Examples of suitable adhesives are materials such as nitro or water varnishes, acrylic varnishes, sol-gel adhesives, polyurethanes, epoxy adhesives and the like.

In one special embodiment of the invention, a substrate of glass or plastic (e.g., a film) is coated by direct application of molecules or monomers with or without subsequent polymerization. That can be done, for instance, in vacuum-coating with materials which are transparent or semitransparent in very thin layers (e.g., 15-200 nm), such as metals (Al, Si or the like) and metal oxides (SiOₓ, AlOₓ or the like). Then the light-absorbing layer is applied over all or part of the surface of this coating which is a barrier to gas, water vapor, and aromas, as by adhering a film containing the dye, painting or printing. In this embodiment, there is the added advantage that the gas, water and aroma barrier can be drastically increased (by a factor of up to about 100) so that “MAPs” (Modified Atmosphere Packagings) are obtained. This yields synergistic effects between the barrier to molecules (thus a barrier to gas such as oxygen, water vapor or aroma substance) and the selective light barrier with little use of material. In addition, a SiOₓ layer can be used as UV protection to extend the lifetime of the dye (e.g., chlorophyll).

Because of the processing of the dye, its transmissive, absorptive, emissive, and/or reflective properties with respect to electromagnetic radiation, e.g., visible and/or UV light, change. Also, the properties of the packaging material itself, if it is a plastic, can be influenced by the presence of the dye. Those properties include improvement of the light stability, modification of the biodegradability and/or improvement of the barrier action (e.g., increasing the O₂ barrier due to the oxygen-consuming action of the dye).

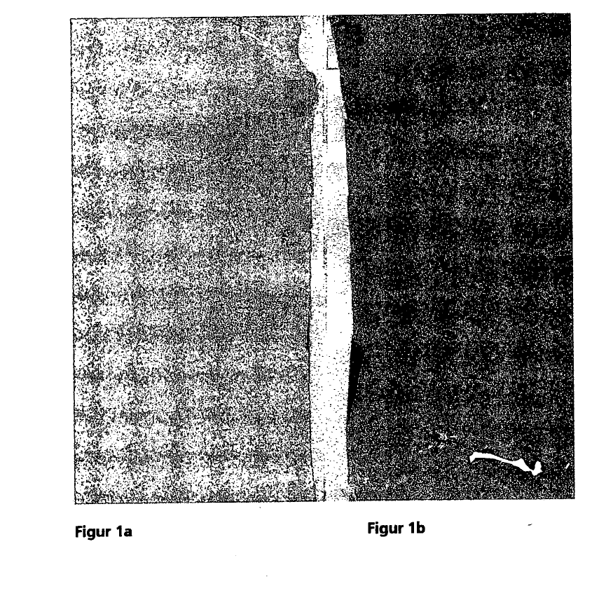

FIG. 1 shows films coated with varnishes containing chlorophyll.

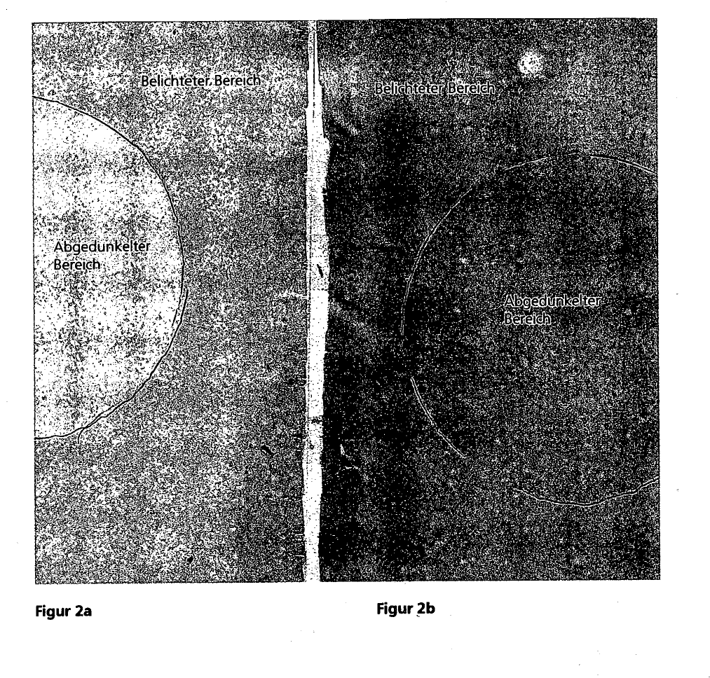

FIG. 2 shows such films which have been exposed to light for some time.

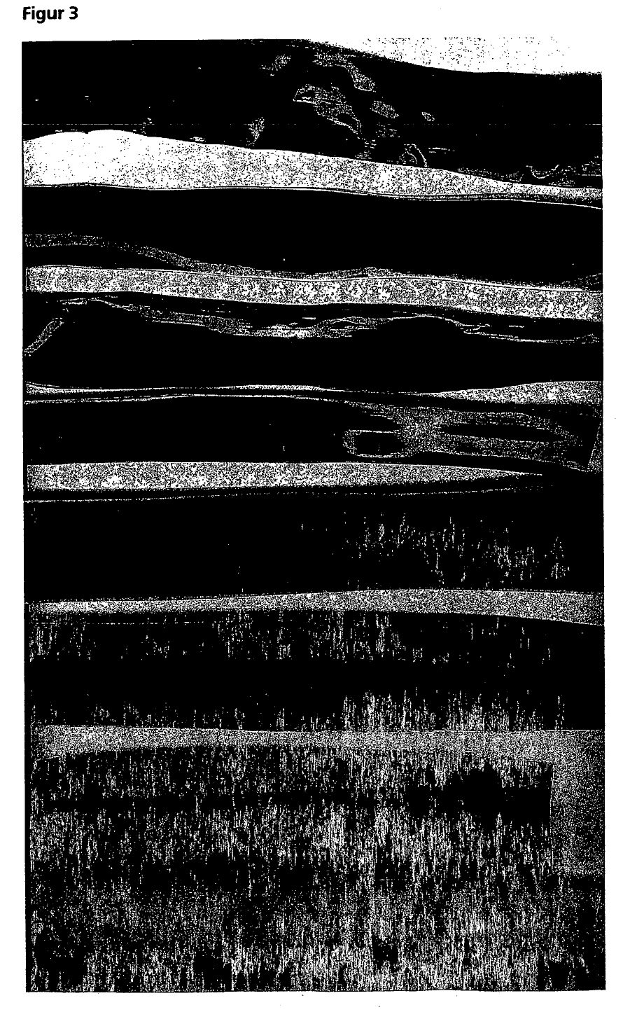

FIG. 3 shows films in which chlorophyll or hemin chloride have been incorporated.

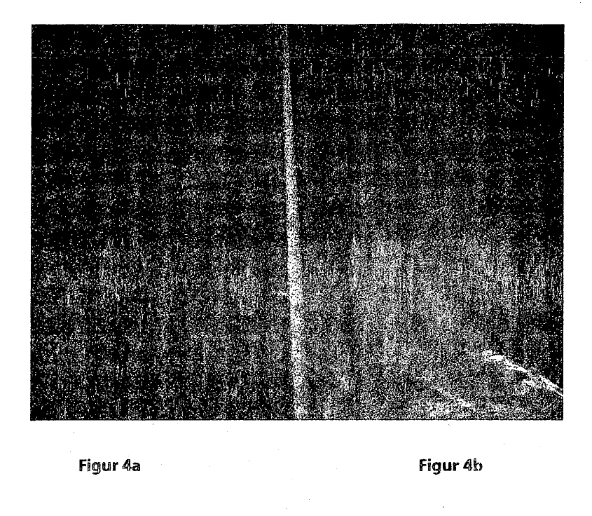

FIG. 4 shows a film containing riboflavin. FIG. 4a shows this film in the unexposed state, while FIG. 4b shows it after 7 weeks exposure to light.

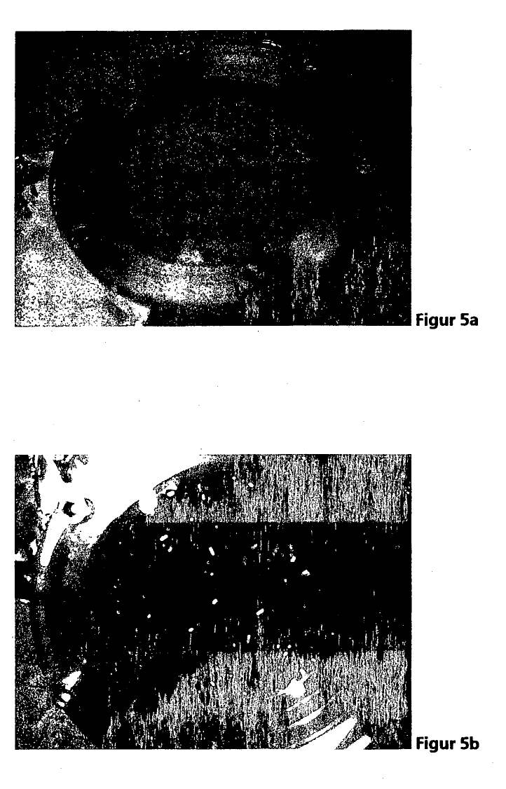

FIG. 5 shows master batches of plastics containing riboflavin and chlorophyll.

The present invention will be explained in more detail by means of examples.

### EXAMPLE 1

This example explains the coating of films of biaxially oriented ypropylene (BOPP). Chlorophyll was used as the natural dye, in various forms:

CHL0: Erka Type 111 chlorophyll (obtainable from Ringe & Kuhlmann, Hamburg; water-soluble powder.

CHL1: 1.0 g chlorophyll powder (CHLO) was dissolved in 50 ml distilled water. The 2%.

clear green solution was used without any other pretreatment.

CHL2:Erka Type 111 chlorophyll as above, but as a 4% aqueous solution (2 g chlorophyll powder to 50 ml distilled water).

CHL3: Erka Type 100/2 chlorophyll (obtainable from Ringe & Kuhlmann, Hamburg; oil

soluble liquid). 0.15 g chlorophyll was added to 50 ml 99% ethanol. A green solution with undissolved particles formed. The particles were filtered out with White Ribbon Filter 589² before use.

The following coating mixtures were prepared:

1 0.30 g methylcellulose (Metylan normal, Henkel/Düsseldorf)+24.03 g CHL2 solution.

2 0.38 g methylcellulose (Metylan normal, Henkel/Düsseldorf)+30.36 g CHL2 solution.

3. 20.34 g water-thinnable acrylic varnish (Holzsiegel/Kronen Areryl 670, colorless,

glossy, Jaeger Moglingen paint factory)+0.80 g CHL0.

4. Nitro-brushing coating (Clou Lack for wood surfaces, glossy, ready to use, Clouth/Offenbach paint factory)+2.01 g CHL3 solution.

5. 19.98 g of a hydrolyzed and condensed silane resin.

6. 40.01 g silane resin as in 5, +20.12 g CHL2 solution.

7. 39.97 g silane resin as in 5, +40.02 g CHL2 solution.

BOPP film (EHB 16 cm, Wolff) was coated on the inner side of the roll (for coating mixtures 5 to 7) or on the outside of the role (for coating mixtures 1 to 4). In each case, a piece of film of DIN A4 size was fixed on a glass plate with transparent tape. Coating mixtures 5 to 7 were knife-coated at an intended wet film thickness of 40 μm. Coating mixtures 1 to 4 were applied at an intended wet film thickness of 100 μm with a film-casting frame. Coatings 5 to 7 were allowed to cure, first overnight at ambient temperature and then for 5 days in an oven before they, like coatings 1 to 4, were stored for 24 hours at room temperature.

Evaluation of the Coated Films:

Peeling of the Film from the BOPP Surface:

1. Intensely dark green coating, adhering well and difficult to peel off, with many green streaks.

2. Intensely green coating, adhering well and difficult to peel off, with fewer green streaks than with Mixture 1.

3. Intensely green coating, adhering well, difficult to peel off.

4. Intensely green coating, adhering well. Additional coatings with 50 μm and 200 μm knives: green and very intensely green, well-adhering coating, difficult to peel off.

5. Distinctly green. The coating peeled easily from the BOPP film surface.

6. Distinctly green. The coating peeled easily from the BOPP film surface.

7. Very green, with bubbly spots throughout. The coating peeled easily from the BOPP surface.

FIGS. 1a and 1b show the coated films 6 and 7. FIGS. 2a and 2b show the same films with color differences after about the sixth week of partial exposure (color fading in the illuminated region).

### EXAMPLE 2

This example describes production of films colored throughout. PET [poly(ethylene terephthalate)], PS [polystyrene], PE [polyethylene] and PP [polypropylene] were chosen as the film materials. The following parameters were selected:

Incorporation of the Chlorophyll

Hopper Feed Adjustment

The chlorophyll, in oil-soluble form (Erka Type 100/2 from Ringe & Kuhlmann, Hamburg) was injected into the hopper with a metering pump. Auger speed: 15 rpm.

PET

Processing temperature: 260° C.

Chlorophyll addition: 30, 40 or 60 ml/kg PET

Granulation color: glass-clear

Result: clear green ribbon.

PS

In this case a mixture of 80% HI (milk-white) and 20% solid PS (glass-clear) was used.

Processing temperature: 200° C.

Chlorophyll addition: 30 ml/kg PS

Result: translucent green ribbon

PE

HDPE [high-density polyethylene] was used in this case.

Processing temperature: 200° C.

Chlorophyll addition: 30 ml/kg PE

Result: translucent green ribbon

PP

Processing temperature: 180° C.

Chlorophyll addition: 30 ml/kg PP

Result: transparent green ribbon.

Hemin (chloride) can also be processed with the materials listed above. It is piled directly into the hopper in small quantities. The result is a dark brown ribbon.

The ribbons so obtained are shown in FIG. 3. From top to bottom, there are four ribbons of PE, two ribbons of PS, and one ribbon of HDPE which are dyed with chlorophyll. The lowest ribbon is a PS ribbon dyed with hemin chloride.

Alternatively, of course, the dye can be processed into the plastic material first before it is taken to a device for shaping the packaging material. FIG. 5 shows correspondingly dyed plastic granules (master batch), with polyethylene dyed with riboflavin in FIG. 5 and polyethylene dyed with chlorophyll in FIG. 5b.

### EXAMPLE 3

Riboflavin, Erka Type 188, was incorporated in LDPE [low-density polyethylene] flat films with the extrusion technology at different concentrations (0.063 or 0.19% by weight). No change could be detected in the film color during 7 weeks of exposure of the yellow-colored riboflavin films to a Lumilux Plus fluorescent lamp (30 watts). FIG. 4a shows the unexposed film and FIG. 4b the exposed one.

### EXAMPLE 4

A poly(ethylene terephthalate) film 12 μm thick is vacuum-coated with a SiOX layer. A polyethylene film between 30 and 100 μm thick is laminated to the PET film with a polyurethane adhesive (2-5 g/m²). The PE film is extruded with incorporation of 30 ml Erka Type 100/2 chlorophyll (see above) per kg of plastic.

### EXAMPLE 5

Example 4 was repeated, but with the chlorophyll (Erka Type 100/2) at 100 g per kg in the polyurethane adhesive (Liofol UR 7222+UR 6082/21, Henkel, Düsseldorf). The polymethane adhesive containing the chlorophyll was coated on the side of the film exposed to SiOₓ with a laboratory laminator. After the adhesive was rolled on, the corona-treated PE film was added and pressed in the laminator.

### EXAMPLE 6

Study of the protective action of films containing chlorophyll on foods containing chlorophyll.

The experiments were done with the coated films 6 and 7 of Example 1.

The investigations were done as described in ZFL 6/98, 36-38 (see above) and ZFL 01/98 (see above).

The results, with the transmission spectra of the films, are presented in Table II.

6.1 Determination of the Rate of Oxygen Uptake by Illuminated Olive Oil

The oxygen uptake rate is a measure of fat oxidation. The decrease in oxygen in the air space above the surface of an olive oil sample was measured. The sample was covered either with a completely transparent film or with one of films 6 and 7. A sample kept in the dark was used as a reference.

Table II shows that the oxygen uptake of the olive oil is reduced by the chlorophyll-containing films, depending on the amount of chlorophyll in the films. (Film 7 contains twice as much chlorophyll as film 6). With the more intensely colored films, the uptake was reduced to almost one third of that observed with a completely transparent film. The comparative value for the sample kept in the dark shows the amount of oxygen uptake that cannot be avoided even with optimal light protection (e.g., in a metal can).

6.2 Determination of the Induction Time of Olive Oil After Illumination

The induction time is understood to be the time during which a vegetable oil is still intact. If the oil has previously been damaged, that is shown by a shorter induction time (shorter remaining storability).

Determination of the induction time of olive oil samples after illumination for 19 days shows that the value for unprotected illumination decreases to about a tenth of the value for a sample completely protected from light. It can be reduced by a factor of 3 by using the chlorophyll-containing packaging films 6 and 7 of Example 1.

6.3 Determination of the Oxidation Products After Illumination

Hexanal was used as the indicator in the determination of the fat oxidation products. The table shows that olive oil shielded by chlorophyll was no more intensely oxidized even after illumination for 25 days than the oil that was completely protected from light.

TABLE II
Stored, illuminated

| | | Colored film, | Colored film | |
|---|---|---|---|---|
| Protection of olive | Transparent film, | Example 1, | Example 1, | Light excluded |
| oil from light | no additive | film 6 | film 7 | completely |
| Oxygen uptake | 14.052 | 8.876 | 5.043 | 0.073 |
| [mg O₂/15 g oil/10 days] | | | | |
| calculated | | | | |
| Induction time | 1.5 | 3.4 | 4.6 | 10.8 |
| [h]; after 19 days | | | | |
| illumination | 147 | 13 | 11 | 11 |
| Fat oxidation/Hexanal | | | | |
| [counts*10⁴]; after 25 | | | | |
| days illumination | | | | |
| Film data: | | | | |
| Transmission spectra | | | | |
| Lumilux Daylight | 2.763 | 2.229 | 1.7476 | |
| Radiation intensity | | | | |
| [W/m²_{(310-720 nm)}] | 92% | 75% | 58% | |
| equivalent to | | | | |
| Lumilux Interna | 2.913 | 2.413 | 1.892 | |
| Radiation intensity | | | | |
| [W/m²_{(310-720 nm)}] | 92% | 76% | 60% | |
| equivalent to | | | | |
| Transmission | | | | |
| 407 nm | 90% | 12% | 3% | |
| 623 nm | 91% | 50% | 28% | |
| Absorbance | | 0.12 | 0.19 | |

[image]

[image]

[image]

[image]

[image]

[image]

[image]

[image]

[image]

[image]

[image]

[image]

[image]

[image]

[image]

[image]

What is claimed:

1. Packaging material for foods, cosmetics or pharmaceuticals made of, or with use of, plastic and/or glass with one or more natural dyes or dyes identical to the natural ones, characterized in that the packaging material transmits light in at least part of its area and the dye which is natural or identical to the natural one is present in at least one light-transmissive area, being either incorporated into the body of the packaging material and/or in a layer on or within the packaging material.

2. Packaging material according to claim 1, characterized in that the natural dye, or the dye identical to the natural one, is selected from organic, optionally metal-containing, dyes, preferably from chlorophyll, carotenes, carotenoids, riboflavin, hemin or myoglobin, or mixtures of those dyes.

3. Packaging material according to claim 1 or claim 2, characterized in that it is or contains a rigid or semirigid packaging material made of a plastic and the natural dye(s) or dye(s) identical with the natural one(s) is/are incorporated in the plastic material.

4. Packaging material according to claim 1 or claim 2, characterized in that it is a rigid or semirigid packaging material or contains a rigid or semirigid part, characterized in that the rigid or semirigid component or part of it has a coating, a film, or an adhesive layer which contains the natural dye(s) or the dye(s) identical with the natural one(s).

5. Packaging material according to claim 1 or claim 2, characterized in that it is a self-supporting film and the natural dye(s) or the dyes identical with the natural one(s) is/are incorporated in the film material.

6. Packaging material according to claim 1 or claim 2, characterized in that it is a self-supporting composite film and the natural dye(s) or the dye(s) identical with the natural one(s) is/are incorporated into part or all of the area of the material of one or more layers or adhesives in this composite film.

7. Packaging material according to one of the foregoing claims, characterized in that it is produced using a polymer, selected from polyethylene, poly(ethylene terephthalate), polypropylene or polystyrene.

8. Packaging material according to one of the foregoing claims, characterized in that the natural dye(s) or the dye(s) identical with the natural one(s) in the packaging material are subject to fading of less than 70% within two weeks, preferably within 12 weeks, and more strongly preferably within 36 weeks.

9. Packaging material according to claim 8, characterized in that the color fading is less than 50%, and preferably less than 30%.

10. Organically, or optionally inorganically, modified polymer composition which is at least partially light-transmissive after polymerization and/or cross-linking, characterized in that it contains at least one natural dye or dye identical with the natural one.

11. Polymer composition according to claims 10, characterized in that that the specified dye is an organic dye, optionally a metal-containing dye, preferably a natural dye.

12. Use of a dye in at least partially transparent packaging materials to absorb such light radiation in the visible region as has a negative effect on the storability of the goods packed in, or to be packed in, the packaging materials.

13. Use according to claim 12, characterized in that the dyes are natural, identical to the natural ones, partially synthetic or fully synthetic, organic, optionally metal-containing dyes.

14. Use according to claims 12 or 13, in which the packaging material contains at least one dye which is also contained naturally or as an additive in the packaged goods.
